(19) United States
(12) Patent Application Publication
(10) Pub. No.: US 2014/0116863 A1
(43) Pub. Date: May 1, 2014

(54) TOUCH PANEL AND METHOD OF MANUFACTURING THE SAME

(71) Applicant: SAMSUNG ELECTRO-MECHANICS CO., LTD., Suwon (KR)

(72) Inventors: Woo Jin Lee, Suwon (KR); Da Mi Shin, Suwon (KR); Jung Wook Seo, Suwon (KR)

(73) Assignee: SAMSUNG ELECTRO-MECHANICS CO., LTD., Suwon (KR)

(21) Appl. No.: 13/760,819

(22) Filed: Feb. 6, 2013

(30) Foreign Application Priority Data
Oct. 29, 2012 (KR) 10-2012-0120586

(51) Int. Cl. H01H 11/04; H01H 1/06

(52) U.S. Cl. CPC H01H 11/04; H01H 1/06
USPC 200/279; 216/13; 427/535

(57) ABSTRACT

Disclosed herein are a touch panel including: a transparent substrate; an interface layer formed on one surface of the transparent substrate; and a metal mesh type electrode pattern formed on the interface layer, and a method of manufacturing the same. In the case in which the interface layer is formed on the transparent substrate, a mirror surface property of the interface is decreased, thereby making it possible to provide a black oxidation property in which reflectivity of a bonded interface and a color feeling unique to a metal are decreased. Therefore, visibility of the electrode pattern is decreased to suppress a phenomenon that the electrode pattern is viewed by user's eyes, such that visibility of the touch panel is improved, thereby making it possible to improve quality of the touch panel.

### CROSS REFERENCE TO RELATED APPLICATION

This application claims the benefit of Korean Patent Application No. 10-2012-0120586, filed on Oct. 29, 2012, entitled “Touch Panel and Method of Manufacturing the Same”, which is hereby incorporated by reference in its entirety into this application.

### BACKGROUND OF THE INVENTION

1. Technical Field

The present invention relates to a touch panel and a method of manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

In accordance with the rapid advancement of an information-oriented society, the use of computers has more and more been widened; however, it is difficult to efficiently operate products using only a keyboard and a mouse currently serving as an input device. Therefore, the necessity for a device that is simple, has less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In this touch panel, a conductor line is generally made of an indium tin oxide (ITO). However, the ITO has excellent electrical conductivity but is expensive since indium used as a raw material thereof is a rare earth metal. In addition, the indium is expected to be depleted within the next decade, such that it may not be smoothly supplied.

Due to the above-mentioned reason, as disclosed in the following Patent Document 1, research into a technology of forming a conductor line using a metal has been actively conducted. When the conductor line is made of the metal, it is advantageous in that the metal has much more excellent electrical conductivity as compared with the ITO and may be smoothly supplied. However, in the case of the prior art, when the conductor line is made of the metal, there is a visibility problem that the conductor line is viewed by user's eyes, or the like, such that commercialization is difficult.
Patent Document 1: Korean Patent Laid-Open Publication No. 2010-0091497

### SUMMARY OF THE INVENTION

Therefore, in the present invention, it was confirmed that in the case of forming an electrode pattern by reforming a surface of a transparent substrate by plasma treatment, securing a structure of a porous surface by a catalyst forming process including a conditioning process, and then performing electroless plating on the porous surface, excellent adhesion between the transparent substrate and the metal electrode is secured, and the transparent substrate and an interface of a metal plated on the transparent substrate are black-oxidized. The present invention has been completed based on the above-mentioned content.

The present invention has been made in an effort to provide a touch panel capable of increasing adhesion between a transparent substrate and an electrode pattern plated on the transparent substrate and decreasing a phenomenon that an electrode pattern made of a metal is recognized by a user due to black-oxidation of an interface of the metal to improve visibility by forming an interface layer having pores between the transparent substrate and the electrode pattern.

Further, the present invention has been made in effort to provide a method of manufacturing a touch panel having improved visibility.

According to a preferred embodiment of the present invention, there is provided a touch panel including: a transparent substrate; an interface layer formed on one surface of the transparent substrate; and a metal mesh type electrode pattern formed on the interface layer, wherein the interface layer has a thickness of 40 to 80 nm, a pore size of 20 to 200 nm, and porosity of 30 to 50%.

The surface of the transparent substrate may have an arithmetic mean roughness (Ra) of 100 nm or less.

A bonded surface between the interface layer and the electrode pattern may have a color difference of a ΔE*ab value of 50 or less and a C*ab value of 20 or less.

The transparent substrate may be made of any one of polyethylene terephthalate (PET), polyimide (PT), polycarbonate (PC), and triacetyl cellulose (TAC) films.

The transparent substrate may be coated with an acryl based primer, a urethane based primer, or a polyvinylidene chloride primer.

The interface layer may have a catalyst sorbed thereon, wherein the catalyst is selected from a group consisting of palladium (Pd), platinum (Pt), rhodium (Rh), ruthenium (Ru), silver (Ag), gold (Au), and an alloy thereof.

The metal may be copper (Cu), nickel (Ni), tin (Sn), or an alloy thereof.

A metal thin line forming the electrode pattern may have an average line width of 7 μm or less and a thickness of 50 nm to 5 μm.

A cross section of the electrode pattern may have a tapered shape.

According to another preferred embodiment of the present invention, there is provided a method of manufacturing a touch panel, the method including: performing hydrophilic plasma treatment on a surface of a transparent substrate to reform the surface of the substrate so as to include an oxygen function group of 30% or more; treating the reformed surface of the substrate using a surfactant to condition the substrate; allowing the conditioned substrate to contact a catalyst forming solution to sorb a catalyst on the substrate and then reduce the substrate; performing electroless plating on the reduced substrate; forming a photoresist on the plated substrate and then patterning the substrate by exposure and development; and etching the patterned substrate and then peeling off the photoresist to form a metal mesh type electrode pattern.

According to still another preferred embodiment of the present invention, there is provided a method of manufacturing a touch panel, the method including: forming a photoresist on a transparent substrate and then patterning the substrate by exposure and development; performing hydrophilic plasma treatment on a surface of the patterned substrate to reform the surface of the substrate so as to include an oxygen function group of 30% or more; treating the reformed surface of the substrate using a surfactant to condition the substrate; allowing the conditioned substrate to contact a catalyst forming solution to sorb a catalyst on the substrate and then reduce the substrate; peeling off the photoresist; and performing electroless plating using the sorbed catalyst as a seed to form a metal mesh type electrode pattern.

The transparent substrate may be made of any one of polyethylene terephthalate (PET), polyimide (PT), polycarbonate (PC), and triacetyl cellulose (TAC) films.

The method may further include a pretreatment step of coating the surface of the transparent substrate with an acryl based primer, a urethane based primer, or a polyvinylidene chloride primer.

The plasma treatment may be performed using oxygen (O₂) as reactive gas and using at least one selected from a group consisting of nitrogen (N₂), argon (Ar), and carbon tetrafluoride (CF₄) as carrier gas.

The surfactant may be at least one non-ionic surfactant selected from a group consisting of a higher alcohol ethyleneoxide adduct, an alkylphenolethyleneoxide adduct, a polyoxyethylenepolyoxypropylene block polymer, a polyoxyethylenepolyoxypropylene block polymer of ethylenediamine, an ethyleneoxide adduct of higher aliphatic amine, and an ethyleneoxide adduct of aliphatic amide.

A catalyst sorbed on the surface of the substrate may be selected from a group consisting of palladium (Pd), platinum (Pt), rhodium (Rh), ruthenium (Ru), silver (Ag), gold (Au), and an alloy thereof.

The electroless plated metal may be copper (Cu), nickel (Ni), tin (Sn), or an alloy thereof.

The reformed surface of the substrate may have an interface layer having a pore size of 20 to 200 nm, a thickness of 40 to 80 nm, and porosity of 30 to 50%.

The method may further include, after the conditioning, a pre-dip step of dipping the substrate in sulfuric acid or sulfuric acid including a cationic surfactant.

The method may further include black oxidizing a surface of the electroless-plated metal by a black oxide forming agent.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a configuration of a touch panel manufactured according to a preferred embodiment of the present invention;

FIGS. 2A and 2B are, respectively, photographs showing cross sections of a transparent substrate that is plasma-treated according to the preferred embodiment of the present invention and a transparent substrate that is not plasma-treated;

FIGS. 3A and 3B are, respectively, photographs showing cross sections of a central portion and an edge portion of an electrode pattern of the touch panel manufactured according to the preferred embodiment of the present invention;

FIG. 4 is a view sequentially showing a process of forming an electrode pattern by a subtractive method in a method of manufacturing a touch panel according to the preferred embodiment of the present invention;

FIG. 5 is a view sequentially showing a process of forming an electrode pattern by an additive method in the method of manufacturing a touch panel according to the preferred embodiment of the present invention;

FIGS. 6A and 6B are, respectively, photographs of the touch panel manufactured according to the preferred embodiment of the present invention viewed from a metal surface and a bonded surface of the touch panel;

FIGS. 7A and 7B are, respectively, scanning electron microscope (SEM) photographs showing a line width of a metal thin line of an electrode pattern in the case in which an etching time is short and in the case in which the etching time is long; and

FIGS. 8A and 8B are, respectively, SEM photographs showing an upper portion and a cross section of a taper shape of an edge portion of the metal thin line of the electrode pattern of the touch panel manufactured according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

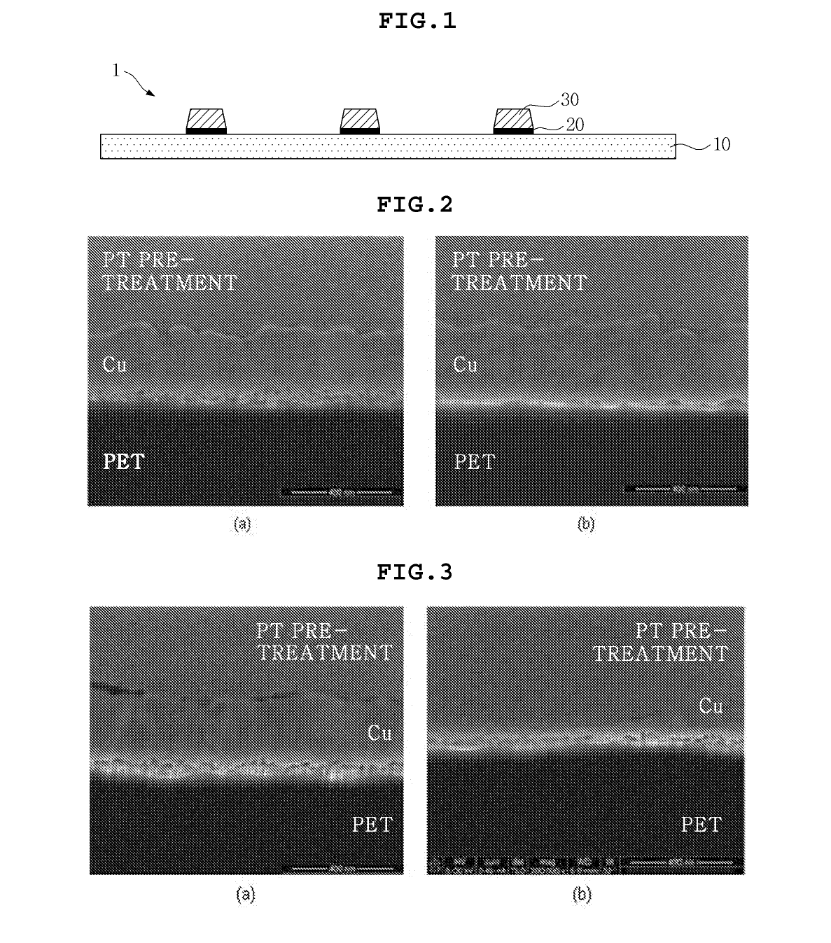

FIG. 1 is a view showing a configuration of a touch panel according to a preferred embodiment of the present invention. As shown in FIG. 1, the touch panel 100 according to the preferred embodiment of the present invention is configured to include a transparent substrate 10, an interface layer 20 formed on one surface of the transparent substrate 10, and a metal mesh type electrode pattern 30 formed on the interface layer 20. Here, the interface layer 20 has a thickness of 40 to 80 nm, a pore size of 20 to 200 nm, and porosity of 30 to 50%.

Transparent Substrate

According to the preferred embodiment, the transparent substrate 10 is a low roughness substrate of which a surface has an arithmetic mean roughness (Ra) of 100 nm or less.

The transparent substrate 10 may have an arithmetic mean roughness of 100 nm or less, preferably, 50 nm or less, most preferably, 10 nm or less in order to maximize a black oxidation effect of an interface between the transparent substrate and a plated metal. In the case in which the surface roughness exceeds 100 nm, it is difficult to secure sufficient adhesion in forming a metal thin line. In addition, optionally, a surface of the transparent substrate 10 is coated with a primer such as an acryl based primer, a urethane based primer, or a polyvinylidene chloride primer, such that the surface roughness may be maintained to be 100 nm or less.

The transparent substrate 10 may be made of, for example, polyethylene terephthalate (PET), polycarbonate (PC), poly methyl methacrylate (PMMA), polyethylene naphthalate (PEN), polyethersulfone (PES), cyclic olefin polymer (COC), triacetylcellulose (TAC) film, polyvinyl alcohol (PVA) film, polyimide (PT) film, polystyrene (PS), biaxially oriented polystyrene (BOPS), or the like, but is not necessarily limited thereto. The transparent substrate 10 may be made of, preferably, polyethylene terephthalate (PET), polyimide (PI), polycarbonate (PC), triacetyl cellulose (TAC) film, or the like.

The surface of the transparent substrate 10 is subjected to plasma treatment to be described below to be activated, thereby making it possible to improve adhesion between an insulating substrate and a metal that is subsequently to be plated.

Interface Layer

According to the preferred embodiment of the present invention, the interface layer 20 is formed on one surface of the transparent substrate 10. More specifically, the interface layer 20 is formed by perform plasma treatment on one surface of the transparent substrate 10 to reform the surface of the substrate so as to include an oxygen functional group of 30% or more and then treating the reformed surface using a surfactant to condition the surface of the substrate.

The plasma treatment according to the preferred embodiment of the present invention may be performed at atmospheric pressure or in a vacuum plasma scheme. In the reforming step of the surface of the substrate through the plasma treatment according to the preferred embodiment of the present invention, the plasma treatment may be performed using oxygen (O₂) as reactive gas and using at least one selected from a group consisting of nitrogen (N₂), argon (Ar), and carbon tetrafluoride (CF₄) as carrier gas.

In the case in which the oxygen is used as the plasma reactive gas, an oxygen radical breaks a hydrogen bond of a polymer of the insulating substrate to generate a hydrophilic functional group such as a carboxyl group, a hydroxyl group, or the like. A general plasma treatment process is a process of allowing plasma to contact a surface to be treated to oxidize, decompose, and remove smear from the surface and at the same time, appropriately remove a material of the surface of the substrate, thereby making the surface of the substrate rough.

However, in the preferred embodiment of the present invention, the hydrophilic functional group such as the hydroxyl group, or the like, may be introduced onto the surface of the substrate through the plasma treatment. Whether or not the hydrophilic functional group is introduced may be confirmed through an increase in an oxygen atom content. According to the preferred embodiment of the present invention, it is required to reform the surface of the substrate so as to include the oxygen functional group of 30% or more. In the case in which a content of oxygen functional group is less than 30%, there is a tendency that it is difficult to form a desired level of pores in the surface in which pores observable after formation of a catalyst layer is formed. As an example of a plasma treatment apparatus usable in the present invention, there may be PCB2800E available from March Plasma Systems. Inc. An example of a specific method and condition of the plasma treatment is as follows.

[Condition of Plasma Treatment]

Gas: CF₄/O₂/N₂, CF₄/O₂/Ar, N₂/O₂, or Ar/O₂

Atmosphere pressure: 10 to 500 mTorr

Output: 500 to 10000 W

Time: 60 to 600 seconds

As an example of the surfactant used for conditioning in the present invention, there may be a cationic surfactant, an anionic surfactant, a non-ionic surfactant, and the like. Among them, the non-ionic surfactant is preferable. As a preferable example of the non-ionic surfactant, there are a higher alcohol ethyleneoxide adduct, an alkylphenolethyleneoxide adduct, a polyoxyethylenepolyoxypropylene block polymer, a polyoxyethylenepolyoxypropylene block polymer of ethylenediamine, an ethyleneoxide adduct of higher aliphatic amine, an ethyleneoxide adduct of aliphatic amide, and the like. Among them, the higher alcohol ethyleneoxide adduct, the alkylphenolethyleneoxide adduct, the polyoxyethylenepolyoxypropylene block polymer, and the like, are particularly preferable as the non-ionic surfactant.

In the case in which the non-ionic surfactant as described above is used, a concentration of the non-ionic surfactant is, preferably, 0.1 to 200 g/l, more preferably, 0.5 to 10 g/l. In the case in which the concentration of the non-ionic surfactant is less than 0.1 g/l, desired wettability may not be obtained. In the case in which the concentration of the non-ionic surfactant exceeds 200 g/l, delamination of a photoresist may be caused, and economic efficiency is deteriorated. A time of this conditioning step is adjusted, thereby making it possible to form preferable pores after a reduction process of a catalyst. Preferably, the conditioning step may be performed for 6 minutes or less.

After the conditioning step, pores having a size of 20 to 200 nm and the interface layer 20 having a thickness of 40 to 80 nm are formed on one surface of the transparent substrate 10. In addition, it is preferable that the interface layer has porosity of 30 to 50% in order to optimize adhesion and black oxidation effect between the interface layer and a plated metal. For example, the interface layer satisfying the pore size and the porosity as described above has a color difference value such as a ΔE*ab value of 50 or less and a C*ab value of 20 or less to decrease reflectivity and a color feeling unique to a metal, such that it is viewed as a dark color.

FIGS. 2A and 2B are, respectively, photographs showing cross sections of a transparent substrate that is plasma-treated according to the preferred embodiment of the present invention and a transparent substrate that is not plasma-treated. Referring to FIGS. 2A and 2B, a difference is generated in whether or not the pores are formed in the interface layer according to whether or not the plasma treatment as in the present invention is performed. In the case in which the plasma treatment is not performed or the plasma treatment is performed in a scheme different from that of the present invention, micro pores are not formed in the interface layer or porosity is low. Therefore, sufficient adhesion is not secured after plating, and an interface layer having decreased reflectivity is not formed. To the contrary, in the case in which the plasma treatment is performed so as to be appropriate for a condition, the micro pores are generated in the interface layer, thereby making it possible to secure improved adhesion.

According to the preferred embodiment of the present invention, after the plasma treatment is performed, a conditioning time is adjusted in a conditioning step by a surfactant, such that the pores may be formed, or the hydrophilic functional group is introduced according to the plasma treatment and the conditioning is performed by the non-ionic surfactant, such that the pores may be formed. This conditioning is performed for, preferably, 6 minutes or less, such that the pores may be formed and the black oxidation may be generated, in the interface according to the preferred embodiment of the present invention. When catalyst sorbing and metal plating are sequentially performed on the formed pore, the black oxidized property allows a metal (copper or nickel) sorbed at a nano particle size according to a shape of the pore to form an interface, which may be confirmed by a phenomenon that it is viewed to be dark.

Metal Mesh Type Electrode Pattern

According to the preferred embodiment of the present invention, electroless plating is performed on the conditioned substrate to form the electrode pattern 30.

Optionally, the conditioned substrate may be subjected to a pre-dip process of dipping the conditioned substrate in sulfuric acid having substantially the same concentration as that of a catalyst forming solution before catalyst sorption. This process is performed in order to raise hydrophilicity of the surface of the substrate to improve a sorption property for a catalyst ion (for example, a palladium ion) contained in the catalyst forming solution or prevent washing water used in the preceding process from being mixed with the catalyst forming solution to allow the catalyst forming solution to be repeatedly reused or promote removal of an oxide film. As a pre-dip solution, sulfuric acid or sulfuric acid including the cationic surfactant is generally used. In order to perform the pre-dip process, the substrate portion is immersed in the pre-dip solution. In addition, after the pre-dip process is performed, washing is not performed.

As a catalyst sorbed on the surface of the substrate, a solution including palladium (Pd), platinum (Pt), rhodium (Rh), ruthenium (Ru), silver (Ag), and gold (Au), most preferably, a solution including palladium may be used. As a solvent, water, an organic solvent, an organic mixed solvent, or a mixed solvent of an organic solvent and water, more preferable, water may be used. The reason is that in the case in which the solvent is the water, a cost is inexpensive and a treating method is simple. For example, an acidic solution (a catalyst forming solution) containing Pd²⁺ ions contacts the surface of the substrate to replace the Pd²⁺ ions with metal Pd on the surface of the substrate by an ionization tendency (Cu+Pd²⁺→Cu²⁺+Pd). The catalyst (for example, Pd) sorbed on the surface of the substrate serves as a catalyst of the electroless plating. As a palladium salt, which is a Pd²⁺ ion supplying source, sulfuric acid palladium or palladium chloride may be used. Since the sulfuric acid palladium has sorption force weaker than that of the palladium chloride and is easy in removing palladium (Pd), it is appropriate for forming a fine line.

Meanwhile, as a sulfuric acid palladium based catalyst forming solution effective for copper, a strong acid solution (for example, KAT-450 available from C. Uemura Co.) containing sulfuric acid, palladium salt, and copper salt or a strong acid solution (for example, MNK-4 available from C. Uemura Co.) containing oxycarboxylic acid, sulfuric acid, and palladium salt is used. Meanwhile, since the palladium chloride has strong sorption force and substitution property and has a difficulty in removing Pd, in the case in which electroless plating is performed under a condition in which the plating is not sorbed, it is possible to prevent the plating from being not sorbed. In order to perform a palladium catalyst forming process, the catalyst forming solution contacts the substrate portion by a method such as an immersion method, a spray method, or the like, and washing is then performed.

In addition, in order to remove impurities, a chelating agent may be generally used. The chelating agent may be absorbed in a surface of a particle to limit growth of the particle in a reaction process and limit an aggregation phenomenon due to a steric hindrance effect, thereby stabilizing a suspension. As the chelating agent, 2-pyridylamine, polyvinyl alcohol (PVA), polyvinyl pyrrolidone (PVP), lauryl sodium sulfate (SDS), dodecylbenzene sulfonic acid sodium (SDBD), cetyltrimethyl ammonium bromide (CTAB), tetraoctyl ammonium bromite (TOAB), polyethylene glycol (PEG), ethylenediamine tetraaceticacid (EDTA), starch, β-cyclodextrin (β-CD), or the like, preferable, 2-pyridylamine may be used. A ratio of a chelating agent to a metal is 1 to 10, preferably, 2 to 6.

Then, the substrate is dipped in a reduction solution by a general method to reduce the sorbed palladium catalyst. For example, the reduction solution includes dimethylamineborane (DMAB), and a reduction time is generally 1 to 10 minutes.

A metal coating formed by the electroless plating according to the preferred embodiment of the present invention may be made of electroless copper, nickel, or a nickel/copper plating. As an electroless nickel plating bath, for example, a plating bath containing a water soluble nickel salt, a reducing agent, and a complex agent may be used. As the water soluble nickel salt, nickel sulfate, nickel chloride, or the like, is used. In addition, a concentration of the water soluble nickel salt is about 0.01 to 1 mol/l. As the reducing agent, hyphosphorous acid salt such as hyphosphorous acid, hyphosphorous acid sodium, or the like, dimethylamineborane, trimethylamineborane, hydrazine, or the like, is used. In addition, a concentration of the reducing agent is about 0.01 to 1 mol/l. As the complex agent, carboxylic acids such as malic acid, succinic acid, lactic acid, citric acid, or sodium salt thereof, or the like, or amino acids such as glycine, alanine, iminodiacetic acid, arginine, glutamic acid, or the like, is used. In addition, a concentration of the complex agent is about 0.01 to 2 mol/l. pH in the plating bath is adjusted to about 4 to 7, and a temperature of the plating bath is adjusted to about 40 to 90° C. In the case in which the hyphosphorous acid is used as the reducing agent in the plating bath, a main reaction as represented by the following Reaction Formula 1 is performed on the surface, such that an Ni plating coating is formed.

Ni²⁺+H₂PO²⁻+H₂O+2e⁻→Ni+H₂PO₃⁻+H₂ [Reaction Formula 1]

As an electroless copper plating bath, for example, a plating bath containing water soluble copper salt, a reducing agent, and a complex agent may be used. As the water soluble copper salt, copper sulfate, copper chloride, or the like, is used. In addition, a concentration of the water soluble copper salt is about 0.01 to 1 mol/l. As the reducing agent, hyphosphorous acid salt such as hyphosphorous acid, hyphosphorous acid sodium, or the like, dimethylamineborane, trimethylamineborane, hydrazine, or the like, is used. In addition, a concentration of the reducing agent is about 0.01 to 1 mol/l. As the complex agent, ethylenediamine-4-acetic acid, tartaric acid, or the like, may be used. A concentration of the complex agent in the electroless copper plating solution is about 0.02 to 0.5 mol/l. In addition, pH of the electroless copper plating solution in the present invention is, preferably, about 10 to 14, more preferably, 12 to 13. Further, it is preferable in view of stability of the plating bath and a precipitation speed of copper that the electroless copper plating solution in the present invention is used at a temperature of the plating bath of 40 to 90° C. In the plating bath, it is preferable that glyoxylic acid is used as the reducing agent in consideration of a bad effect of formalin on a human body or an environment. A concentration of the glyoxylic acid is, preferably, 0.005 to 0.5 mol/l, more preferably, 0.01 to 0.2 mol/l. In the case in which the concentration is less than 0.005 mol/l, a plating reaction does not occur, and in the case in which the concentration exceeds 0.5 mol/l, a plating solution becomes unstable to thereby be decomposed. In the case in which the hyphosphorous acid is used as the reducing agent in the plating bath, a main reaction as represented by the following Reaction Formula 2 is performed on the surface, such that a Cu plating coating is formed.

Cu²⁺+H₂PO²⁻+H₂O+2e⁻→Cu+H₂PO₃⁻+H₂ [Reaction Formula 2]

As a PH adjuster, a generally used adjuster such as sodium hydroxide, potassium hydroxide may be used. However, in the case of avoiding an alkali metal such as sodium, potassium, or the like, as for the purpose of a semiconductor, tetramethylammonium hydroxide may be used.

In the present invention, optionally, the surface of the metal coating formed by the electroless plating may be black oxidized by a black oxide forming agent. The black oxidation is performed in order to minimize light reflection in the case in which both surface of the substrate is plated with a metal. As a method of performing the black oxidation, various methods are well-known in the art. Among the well-known methods, an appropriate method may be selected and used.

According to the preferred embodiment of the present invention, the metal plated coating having the black oxidized interface is etched by an etching process, is removed using laser and then patterned, or the interface layer is formed on the patterned photoresist and then plated with the metal, thereby making it possible to form an electrode pattern.

It is preferable that a metal thin line forming the electrode pattern has an average line width of 7 μm or less and a thickness of 50 nm to 5 μm. In implementing an apparatus sensitive to visibility, such as a touch panel, it is important to decrease visibility of the electrode pattern. To this end, preferably, the line width should be 7 μm or less and a surface thereof should have low reflectivity. The decrease in the reflectivity of the surface may be accomplished using the surface treatment according to the preferred embodiment of the present invention. Generally, in the case in which the metal mesh line wide is 7 μm or more, the visibility by human eyes is rapidly increased. In addition, in the case in which the thickness of the electrode pattern is 50 nm to 5 μm, the visibility of the electrode pattern may be minimized.

According to the preferred embodiment of the present invention, a cross section of the electrode pattern has a tapered shape. One of the most important elements in the transparent electrode using the metal thin line is to decrease the visibility, that is, a phenomenon that an opaque metal line is viewed by the human eyes. According to the preferred embodiment of the present invention, the interface of the metal plated coating is first black oxidized, thereby making it possible to improve the visibility through a decrease in the reflectivity and a change of a color feeling in the case of implementing the same line width and uniformly decrease a line width using over-etching, which may generate a process cost decrease effect. Here, it may be confirmed that a taper is generated at an edge portion of the metal thin line. This taper, which is a shape appearing when an etching method is used, has a deviation in a thickness, but is uniformly generated over the entire portion, such that there is no unique matter. Rather, the thickness at the edge portion becomes thin, thereby making it possible to minimize a phenomenon that the metal thin line is viewed in a thickness direction. FIGS. 3A and 3B are, respectively, photographs showing cross sections of a central portion and an edge portion of an electrode pattern of the touch panel manufactured according to the preferred embodiment of the present invention. As shown in FIGS. 3A and 3B, it may be confirmed that the electrode pattern has a thickness thinner at the edge portion thereof than at the central portion thereof.

In a method of manufacturing a touch panel according to the preferred embodiment of the present invention, the metal mesh type electrode pattern may be formed by a subtractive or additive method.

In the case of using the subtractive method, the touch panel according to the preferred embodiment of the present invention may be manufactured by performing hydrophilic plasma treatment on a surface of a transparent substrate to reform the surface of the substrate so as to include an oxygen function group of 30% or more, treating the reformed surface of the substrate using a surfactant to condition the substrate, allowing the conditioned substrate to contact a catalyst forming solution to sorb a catalyst on the substrate and then reduce the substrate, performing electroless plating on the reduced substrate, forming a photoresist on the plated substrate and then patterning the substrate by exposure and development, and etching the patterned substrate and then peeling off the photoresist to form a metal mesh type electrode pattern.

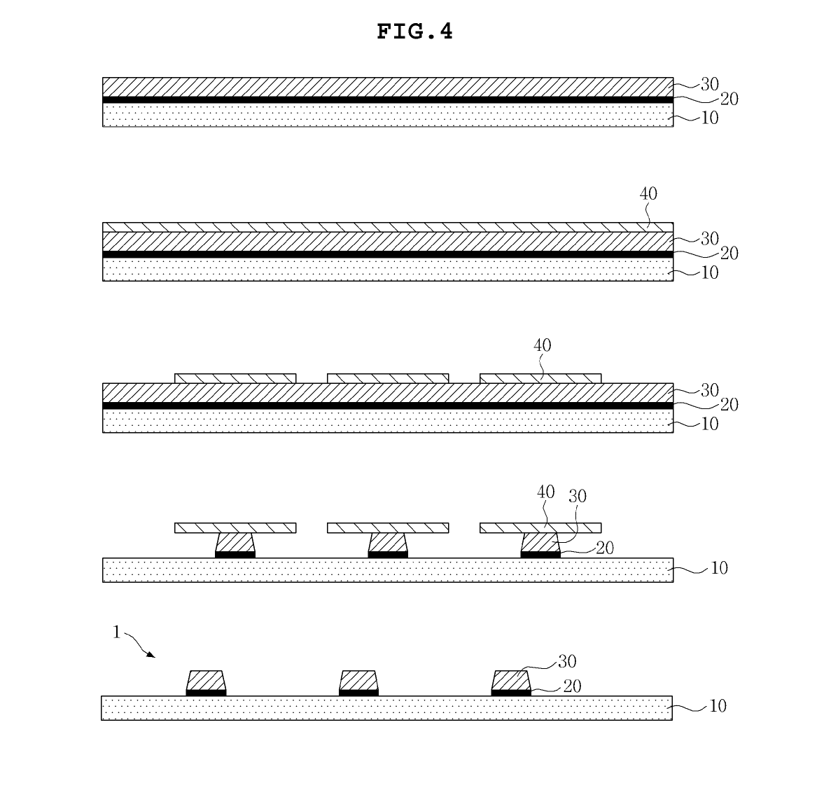

FIG. 4 is a view sequentially showing a process of forming an electrode pattern 30 by a subtractive method in a method of manufacturing a touch panel 100 according to the preferred embodiment of the present invention. Here, a photoresist may be formed by laminating a film such as a dry film or be formed by printing or coating a liquid photoresist. That is, a form of the photoresist is not limited. Generally, in the case in which the dry film is laminated on a copper surface, a resist may have a line width of about 6 to 10 μm in view of practicality. After the photoresist is formed, the substrate is over-etched at a width wider than a line width of the photoresist using a persulfuric acid aqueous solution or other appropriate etching solutions such as solution solutions of Cu, Ni, Sn, or the like, to form the metal thin line, thereby making it possible to form a circuit having a fine line width. Generally, just etching means that a pattern is formed at the same width as a width of a resist according to a design value. However, an undercut is generated under the photoresist due to isotropy of the etching. In etching a metal thin film as in the present invention, a change of a side of the pattern as described above allows an aspect ratio to be different from an actual aspect ratio of a printed circuit board. That is, this case corresponds to a case in which an aspect ratio is low, that is, a case in which a thickness is thinner as compared with a line width. Therefore, an effect due to a shape of the side is not very large, and an over-etching time is adjusted, thereby making it possible to implement a line width thinner than a pattern width of the photoresist.

An advantage of this method is to decrease a process cost. Generally, in order to form a fine pattern width, a used photoresist should also be elaborate. Generally, in order to implement a photoresist having a thickness of 5 μm or less, a liquid photoresist (for example, AZ5214, AZ1512, or the like) formed by spin coating, or the like, and having a thin thickness should be used. In this case, a process is complicated and a cost is also high. However, in the case of using the over-etching as described above, the line width of the photoresist may be larger than a line width to be formed. In this case, since a dry film that is generally used in a printed circuit board process may be used, a process cost may be decreased.

An actual result of forming a plated coating having the interface layer 20 according to the preferred embodiment of the present invention at a thickness of 400 to 500 nm on one surface of the transparent substrate 10, forming the photoresist 40, and then implementing a pattern by etching corresponds to the touch panel 100 having the metal mesh type electrode pattern 40 as shown in FIG. 4.

In the case of using the additive method, the touch panel according to the preferred embodiment of the present invention may be manufactured by forming a photoresist on a transparent substrate and then patterning the substrate by exposure and development, performing hydrophilic plasma treatment on a surface of the patterned substrate to reform the surface of the substrate so as to include an oxygen function group of 30% or more, treating the reformed surface of the substrate using a surfactant to condition the substrate, allowing the conditioned substrate to contact a catalyst forming solution to sorb a catalyst on the substrate and then reduce the substrate, peeling off the photoresist, and performing electroless plating using the sorbed catalyst as a seed to form a metal mesh type electrode pattern.

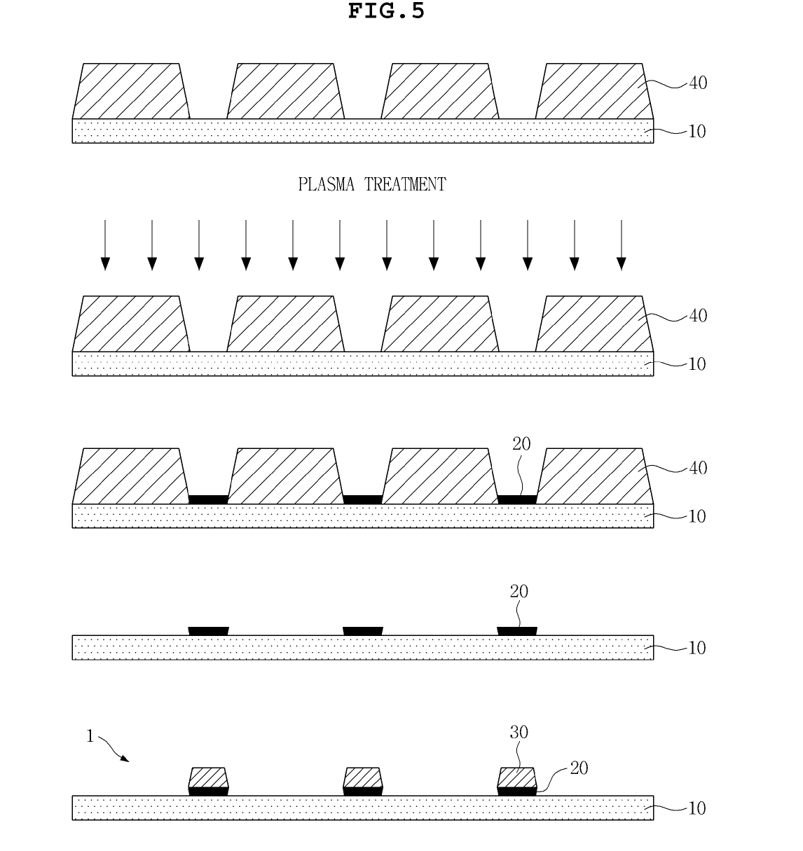

FIG. 5 shows a process of forming a metal mesh type electrode pattern by an additive method. Referring to FIG. 5, this process has a sequence similar to that of a general additive method, but is different therefrom only in that a plasma treatment process that has been used as means for accomplishing the structure having the black oxidized interface layer, which is a main point of the present invention, is added. Through the above-mentioned process sequence, the electrode pattern may be formed even by the additive method. In this case, since a line width that is to be implemented is determined by a pattern width of the photoresist, it is likely that a process cost will be increased as compared with the subtractive method; however, a disconnection risk due to badness of an etching adjustment time may be reduced, it may be applied to the process in consideration of yield.

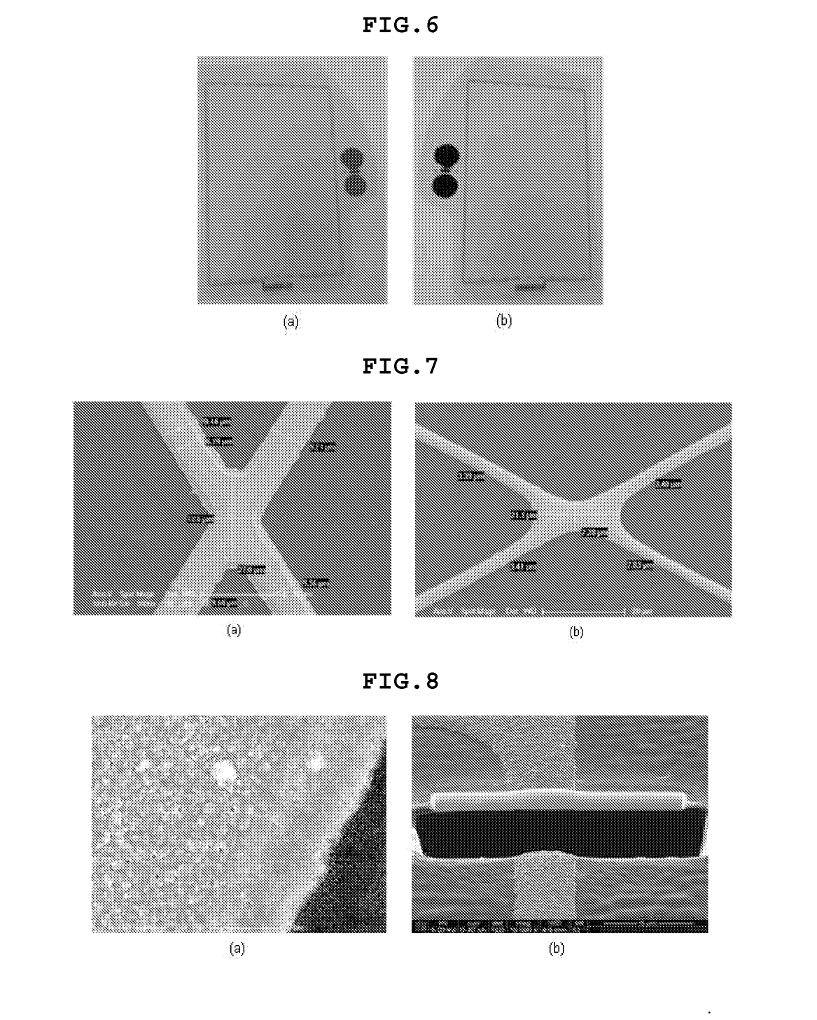

FIGS. 6A and 6B are, respectively, photographs of the touch panel manufactured according to the preferred embodiment of the present invention viewed from a metal surface and a bonded surface of the touch panel. Referring to FIGS. 6A and 6B, a line width of the metal mesh type electrode pattern formed according to the preferred embodiment of the present invention may be 10 μm or less. As obviously seen in a round test pad of FIG. 6A, it is clearly viewed that a dark color appears due to a low reflective black oxide property of the plated interface. This property of the interface is also reflected in a sensor unit in which a mesh is formed, such that a color feeling unique to copper appearing when viewed from a front surface and reflectivity of the metal mesh is decreased. A quantitative effect of the black oxidation may be measured by a color difference meter. The following Table 1 shows examples of actual measured values.

TABLE 1

| Division | L* | a* | b* | ΔE*ab | C*ab |
|---|---|---|---|---|---|
| Non-black | 79.55 | 14.58 | 21.66 | 83.64 | 26.11 |
| oxidized | | | | | |
| interface | | | | | |
| Black oxidized | 29.18 | 0.76 | −2.63 | 29.22 | 2.74 |
| interface | | | | | |

In the above Table 1, a ΔE*ab value corresponds to a total reflection amount in which a color feeling is considered. It could be confirmed in Table 1 that reflectivity of the black oxidized interface is 29.22, which is decreased as compared with 83.64 corresponding to reflectivity of the non-black oxidized interface. In addition, a C*ab value corresponds to a color different. It could be confirmed in Table 1 that the C*ab value of the black oxidized copper surface is 2.74, which is significantly decreased as compared with 26.11 of the non-black oxidized copper surface. This means that a color feeling becomes close to a black color. The black oxidation mentioned in the present specification means that the reflectivity is decreased as described above, such that the color feeling becomes close to the black color.

The change of the color that may be observed as described above is also reflected in the transparent electrode in which the mesh electrode is formed according to an occupation ratio of the metal surface. This change is reflected so that a difference is viewed at the time of observation with the naked eyes, such that the change of the color feeling and the change of the reflectivity play an important role in decreasing the visibility of the pattern.

In addition, in manufacturing the touch panel according to the preferred embodiment of the present invention, it is important to form a fine line width. At the time of considering only electrical characteristics, at the same thickness, the wider the line width, the better the electrical characteristics. However, in the case of the metal mesh type transparent electrodes, when the line width is thick, since it is viewed by the human eyes, the line width should be as narrow as possible. FIGS. 7A and 7B are, respectively, scanning electron microscope (SEM) photographs showing a line width of a metal thin line of an electrode pattern in the case in which an etching time is short and in the case in which the etching time is long. As shown in FIGS. 7A and 7B, it could be confirmed that in the case of forming a photoresist having a line width of 11 μm and then performing the patterning according to the preferred embodiment of the present invention, line widths are different according to an etching time.

As described above, one of the most important elements in the transparent electrode using the metal thin line is to decrease the visibility, that is, a phenomenon that an opaque metal line is viewed by the human eyes. According to the preferred embodiment of the present invention, the bonded surface is first black oxidized, thereby making it possible to improve the visibility through a decrease in the reflectivity and a change of a color feeling in the case of implementing the same line width and uniformly decrease a line width using the over-etching, which may generate a process cost decrease effect. Here, it may be confirmed that a taper is generated at an edge portion of the metal thin line. This taper, which is a shape appearing when an etching method is used, has a deviation in a thickness, but is uniformly generated over the entire portion, such that there is no unique matter. Rather, the thickness at the edge portion becomes thin, thereby making it possible to minimize a phenomenon that the metal thin line is viewed in a thickness direction.

FIGS. 8A and 8B are, respectively, SEM photographs showing a taper shape of an edge portion of the metal thin line of the electrode pattern of the touch panel manufactured according to the preferred embodiment of the present invention. In FIG. 8A, which is a photograph viewed from an upper portion of the edge portion, it may be viewed that an inclination surface is formed at an interface portion, which may be more obviously viewed of a cross section photograph of FIG. 8B. The edge portion becomes thin as described above, thereby making it possible to assist in decreasing a phenomenon that the metal thin line is viewed.

According to the preferred embodiment of the present invention, it may be confirmed to implement a fine line width circuit having a structure of adjusting a viewed portion of the pattern to have low reflectivity using the general subtractive or additive method used in a process of manufacturing a printed circuit board. It may also be confirmed that features of the electrode pattern due to this assist in decreasing the visibility.

As set forth above, with the touch panel and the method of manufacturing the same according to the preferred embodiments of the present invention, the visibility of the electrode pattern is decreased by the black oxidized interface layer applied to the touch panel to suppress a phenomenon that the electrode pattern is viewed by user's eyes, such that the visibility of the touch panel is improved, thereby making it possible to improve quality of the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a transparent substrate;
an interface layer formed on one surface of the transparent substrate; and
a metal mesh type electrode pattern formed on the interface layer,
wherein the interface layer has a thickness of 40 to 80 nm, a pore size of 20 to 200 nm, and porosity of 30 to 50%.

2. The touch panel as set forth in claim 1, wherein the surface of the transparent substrate has an arithmetic mean roughness (Ra) of 100 nm or less.

3. The touch panel as set forth in claim 1, wherein a bonded surface between the interface layer and the electrode pattern has a color difference of a ΔE*ab value of 50 or less and a C*ab value of 20 or less.

4. The touch panel as set forth in claim 1, wherein the transparent substrate is made of any one of polyethylene terephthalate (PET), polyimide (PI), polycarbonate (PC), and triacetyl cellulose (TAC) films.

5. The touch panel as set forth in claim 1, wherein the transparent substrate is coated with an acryl based primer, a urethane based primer, or a polyvinylidene chloride primer.

6. The touch panel as set forth in claim 1, wherein the interface layer has a catalyst sorbed thereon, the catalyst being selected from a group consisting of palladium (Pd), platinum (Pt), rhodium (Rh), ruthenium (Ru), silver (Ag), gold (Au), and an alloy thereof.

7. The touch panel as set forth in claim 1, wherein the metal is copper (Cu), nickel (Ni), tin (Sn), or an alloy thereof.

8. The touch panel as set forth in claim 1, wherein a metal thin line forming the electrode pattern has an average line width of 7 μm or less and a thickness of 50 nm to 5 μm.

9. The touch panel as set forth in claim 1, wherein a cross section of the electrode pattern has a tapered shape.

10. A method of manufacturing a touch panel, the method comprising:
performing hydrophilic plasma treatment on a surface of a transparent substrate to reform the surface of the substrate so as to include an oxygen function group of 30% or more;
treating the reformed surface of the substrate using a surfactant to condition the substrate;
allowing the conditioned substrate to contact a catalyst forming solution to sorb a catalyst on the substrate and then reduce the substrate;
performing electroless plating on the reduced substrate;
forming a photoresist on the plated substrate and then patterning the substrate by exposure and development; and
etching the patterned substrate and then peeling off the photoresist to form a metal mesh type electrode pattern.

11. A method of manufacturing a touch panel, the method comprising:
forming a photoresist on a transparent substrate and then patterning the substrate by exposure and development;
performing hydrophilic plasma treatment on a surface of the patterned substrate to reform the surface of the substrate so as to include an oxygen function group of 30% or more;
treating the reformed surface of the substrate using a surfactant to condition the substrate;
allowing the conditioned substrate to contact a catalyst forming solution to sorb a catalyst on the substrate and then reduce the substrate;
peeling off the photoresist; and
performing electroless plating using the sorbed catalyst as a seed to form a metal mesh type electrode pattern.

12. The method as set forth in claim 10, wherein the transparent substrate is made of any one of polyethylene terephthalate (PET), polyimide (PT), polycarbonate (PC), and triacetyl cellulose (TAC) films.

13. The method as set forth in claim 11, wherein the transparent substrate is made of any one of polyethylene terephthalate (PET), polyimide (PI), polycarbonate (PC), and triacetyl cellulose (TAC) films.

14. The method as set forth in claim 10, further comprising a pretreatment step of coating the surface of the transparent substrate with an acryl based primer, a urethane based primer, or a polyvinylidene chloride primer.

15. The method as set forth in claim 11, further comprising a pretreatment step of coating the surface of the transparent substrate with an acryl based primer, a urethane based primer, or a polyvinylidene chloride primer.

16. The method as set forth in claim 10, wherein the plasma treatment is performed using oxygen (O₂) as reactive gas and using at least one selected from a group consisting of nitrogen (N₂), argon (Ar), and carbon tetrafluoride (CF₄) as carrier gas.

17. The method as set forth in claim 11, wherein the plasma treatment is performed using oxygen (O₂) as reactive gas and using at least one selected from a group consisting of nitrogen (N₂), argon (Ar), and carbon tetrafluoride (CF₄) as carrier gas.

18. The method as set forth in claim 10, wherein the surfactant is at least one non-ionic surfactant selected from a group consisting of a higher alcohol ethyleneoxide adduct, an alkylphenolethyleneoxide adduct, a polyoxyethylenepolyoxypropylene block polymer, a polyoxyethylenepolyoxypropylene block polymer of ethylenediamine, an ethyleneoxide adduct of higher aliphatic amine, and an ethyleneoxide adduct of aliphatic amide.

19. The method as set forth in claim 11, wherein the surfactant is at least one non-ionic surfactant selected from a group consisting of a higher alcohol ethyleneoxide adduct, an alkylphenolethyleneoxide adduct, a polyoxyethylenepolyoxypropylene block polymer, a polyoxyethylenepolyoxypropylene block polymer of ethylenediamine, an ethyleneoxide adduct of higher aliphatic amine, and an ethyleneoxide adduct of aliphatic amide.

20. The method as set forth in claim 10, wherein a catalyst sorbed on the surface of the substrate is selected from a group consisting of palladium (Pd), platinum (Pt), rhodium (Rh), ruthenium (Ru), silver (Ag), gold (Au), and an alloy thereof.

21. The method as set forth in claim 11, wherein a catalyst sorbed on the surface of the substrate is selected from a group consisting of palladium (Pd), platinum (Pt), rhodium (Rh), ruthenium (Ru), silver (Ag), gold (Au), and an alloy thereof.

22. The method as set forth in claim 10, wherein the electroless plated metal is copper (Cu), nickel (Ni), tin (Sn), or an alloy thereof.

23. The method as set forth in claim 11, wherein the electroless plated metal is copper (Cu), nickel (Ni), tin (Sn), or an alloy thereof.

24. The method as set forth in claim 10, wherein the reformed surface of the substrate has an interface layer having a pore size of 20 to 200 nm, a thickness of 40 to 80 nm, and porosity of 30 to 50%.

25. The method as set forth in claim 11, wherein the reformed surface of the substrate has an interface layer having a pore size of 20 to 200 nm, a thickness of 40 to 80 nm, and porosity of 30 to 50%.

26. The method as set forth in claim 10, further comprising, after the conditioning, a pre-dip step of dipping the substrate in sulfuric acid or sulfuric acid including a cationic surfactant.

27. The method as set forth in claim 11, further comprising, after the conditioning, a pre-dip step of dipping the substrate in sulfuric acid or sulfuric acid including a cationic surfactant.

28. The method as set forth in claim 10, further comprising black oxidizing a surface of the electroless-plated metal by a black oxide forming agent.

29. The method as set forth in claim 11, further comprising black oxidizing a surface of the electroless-plated metal by a black oxide forming agent.
